(19) United States
(12) Patent Application Publication
(10) Pub. No.: US 2026/0249506 A1
(43) Pub. Date: Aug. 27, 2026

(54) Device and Method for Cutting Food Bars

(71) Applicant: GEA Food Solutions Germany GmbH, Biedenkopf-Wallau (DE)

(72) Inventors: Martin Knura, Lorch (DE); Norbert Brunnquell, Altusried (DE)

(21) Appl. No.: 19/489,693

(22) PCT Filed: Jul. 26, 2024
(86) PCT No.: PCT/EP2024/071262

§ 371 Date: Dec. 3, 2025

(30) Foreign Application Priority Data
Jul. 28, 2023 (DE) 10 2023 207 256.4

(51) Int. Cl. B26D 7/30; B26D 7/06

(52) U.S. Cl. CPC B26D 7/30; B26D 7/0625; B26D 2210/02

(57) ABSTRACT

Device for cutting food bars that includes a cutting device for cutting food bars into product slices and a food feed device, the food feed device has a conveyor belt for feeding the food bars to the cutting device, and a weighing device associated with the food feeding device for weighing the food bar.

### CROSS REFERENCE TO RELATED APPLICATIONS

This application is a US National Stage Entry of PCT/EP2024/071262 filed on Jul. 26, 2024, which claims priority to DE 10 2023 207 256.4 filed on Jul. 28, 2023, all of which are hereby incorporated by reference herein in their entireties for all purposes.

### FIELD

The invention relates to a device for cutting food bars, comprising a cutting device for cutting one or more food bars into product slices and a food feed device, wherein the food feed device comprises a conveyor belt for feeding the food bars to the cutting device. The invention also relates to a method for cutting food bars, wherein one or more food bars are fed to a cutting device for cutting.

### BACKGROUND

Such devices are generally known and are typically referred to as slicers or high-performance slicers. Basically, with such slicers, the food products are loaded onto the food feed device of the slicer by means of an external loading device. If you want to determine the weight of these food products before cutting, a scale must be inserted between the food feed device and the external loading device. The disadvantage of this configuration is that the scale must be at least as long as the longest food product to be sliced by the slicer, resulting in a comparatively large loss of installation space.

Against this background, the task is to provide a device and a method that enables integrated and thus space-saving weighing of a food bar in a cutting device before the food bar is cut.

### SUMMARY

The task is solved by a device for cutting food bars comprising a cutting device for cutting food bars into product slices and a food feed device, wherein the food feed device ( ) comprises a conveyor belt for feeding the food bars to the cutting device, wherein the device comprises a weighing device associated with the food feed device for weighing the food bars.

The device for cutting food bars according to the invention, in particular a slicer or high-performance slicer, has the advantage over the prior art that no additional device for weighing is required upstream of the food feed device, so that the entire arrangement or line can be designed to be more compact. According to the invention, the weighing device is associated with the food feed device of the device. In the sense of the present invention, this means in particular that the weighing device is integrated into the food feed device. Consequently, the arrangement of the weighing device in combination with the food feed device enables a space-saving device.

Advantageous embodiments and further developments of the invention can be found in the subclaims and in the description with reference to the drawings.

According to a preferred embodiment of the present invention, the conveyor belt has a conveyor plane, wherein the weighing device associated with the conveyor belt has a load cell with a lifting device, wherein the lifting device is movable between a working position and a rest position through the conveyor plane, wherein the lifting device is located substantially above the conveyor plane in the working position and substantially below the conveyor plane in the rest position, wherein the weighing cell is configured such that, in the working position, the weight of the food bars lying on the weighing cell in the working position can be determined. Advantageously, the lifting device can thus be used to lift the food bars during feeding, thereby enabling the weight of the food bars to be determined effectively and efficiently by the weighing cell in the lifting device. The weighing cell is preferably moved vertically to the conveyor plane, whereby the weighing cell is moved from a rest position largely below the conveyor plane to a working position largely above the conveyor plane. Vertical movement of the weighing cell represents a simple and space-saving way of weighing a food bar.

In an alternative embodiment of the invention, the load cell can be moved continuously between the rest position and the working position. Depending on the weight of the food bar, the conveyor belt may have a preload force, whereby a high preload force should not place an unnecessary load on the weighing cell due to the tensile force of the conveyor belt. This means that weighing is also possible within these different relative positions.

According to a preferred embodiment of the present invention, the conveyor belt is pivotable between a loading position and a feeding position by means of a lifting drive, wherein the weighing device associated with the conveyor belt has a power evaluation unit for determining the power consumption of the lifting drive, wherein the power evaluation unit is configured such that the weight of the food bars can be determined as a function of the power consumption of the lifting drive. The lifting drive can move the conveyor belt from a loading position for picking up food bars to a feeding position for feeding the products to the cutting device, wherein the movement of the lifting drive enables, in particular, a rotary movement of the conveyor belt about a fixed point. Instead of the rotary movement of the conveyor belt, movement in space around at least two axes is also possible, such as an asymmetrical scissor lift table.

The loading position is preferably an essentially horizontal position of the conveyor belt in which the food bars are fed to the conveyor belt. Furthermore, the feeding position can be a new position of the conveyor belt rotated by a feeding angle relative to the loading position, whereby in the feeding position the food bars already lying on the conveyor belt are fed to the cutting device. The lifting drive can be, for example, a spindle drive or a gear motor with a servo drive, in which the lifting force is transmitted by means of flat belts, toothed belts, wire ropes or the like, or it can also have a pneumatic or hydraulic cylinder, which generates the lifting movement of the conveyor belt. In principle, other drive types are also conceivable, such as a coupling cam or swing arm.

In a spindle drive, an electric motor can be connected to the conveyor belt via a spindle, whereby a spindle is a simple mechanical connection and is less prone to failure. The power required by the electric motor or gear motor with servo drive to lift the conveyor belt from the loading position to the feeding position ( ) is preferably also dependent on the weight of the food bars on the conveyor belt. In particular, the lifting force is transmitted by means of a toothed belt, thereby lifting the conveyor belt with the food bars on it. The power evaluation unit can then determine the weight of the food bars based on the power required, whereby the weight of the conveyor belt and other elements is calculated out of the equation by the evaluation unit. Examples include deflection rollers and the weight of the conveyor belt. Alternatively, it is also conceivable that the conveyor belt could be pivoted by means of a pivot bearing or radial bearing on the axis of rotation of the conveyor belt and the pneumatic or hydraulic cylinder on the opposite side. This would make it possible to determine the weight of the food bars using the power evaluation unit based on the power required by the pneumatic or hydraulic cylinder. The weight of the deflection rollers or the weight of the conveyor belt would also have to be taken into account when calculating the weight. Preferably, the evaluation unit determines the weight of the food bars based on the power consumption of the lifting drive in combination with the measured or previously defined or provided feed angle of the conveyor belt. The feed angle of the conveyor belt can affect the weight exerted on the conveyor belt by the food bars. The spindle drive or gear motor with a servo drive, the pneumatic and hydraulic cylinders are infinitely adjustable for moving the conveyor belt.

According to a preferred embodiment of the present invention, the conveyor belt is pivotable between a loading position and a feed position by means of a lifting drive, wherein the weighing device has one or more load cells arranged on the left and right, which are arranged in the area of a pivot axis of the conveyor belt and measure the weight of the food feed device in the loading position. It is conceivable that the load cell(s) is/are arranged in the area of the pivot axis bearing or in the area of a bracket below the pivot axis bearing. Advantageously, the entire weight of the food feed device acts on the load cell(s) and lifting drive when the conveyor belt is in the loading position, so that the weight of the food bar on the conveyor belt can be inferred by detecting the difference in weight (empty conveyor belt versus products on the conveyor belt).

Alternatively or additionally, it is conceivable that the conveyor belt can be pivoted between a loading position and a feeding position by means of a lifting drive, wherein the weighing device has a load cell arranged in the area of a pivot axis of the conveyor belt and a further load cell arranged in the area of a deflection roller of the conveyor belt, wherein the load cell and the further load cell together measure the weight of the food feed device in the loading position. It is conceivable that the additional load cell is arranged in the bearing of the deflection roller for the belt of the conveyor belt or in its holder. Advantageously, the weight of a food bar arranged on the conveyor belt can then be measured by means of both load cells, even when the conveyor belt is in the loading position.

According to a preferred embodiment of the present invention, the conveyor belt is pivotable between the loading position and the feeding position by means of a lifting belt (or similar), wherein the lifting belt has a lifting belt strain gauge, wherein the weighing device associated with the conveyor belt has a lifting belt evaluation unit for detecting a change in length of the lifting belt strain gauge, wherein the lifting belt evaluation unit is configured such that the weight of the food bar located on the conveyor belt can be determined as a function of the change in length or width of the lifting belt strain gauge. In particular, the lifting belt can be attached to a gear motor with a servo drive and transmit the lifting force to it by means of a toothed belt. This allows the conveyor belt, equipped with the pivot bearing or radial bearing on one side (axis of rotation) and a fastening to the lifting belt on the other side, to be raised and lowered in a convenient manner. The (weight) force acting on the lifting belt provides information about the weight of the conveyor belt with the food bar on it. The change in length in the lifting belt is indicated by the (weight) force acting on the lifting belt. The lifting belt evaluation unit can then be used to record the change in length and, by calculating the change in length when the conveyor belt is lifted without the food bar on it, determine the weight of the food bar on the conveyor belt.

The lifting belt strain gauge is preferably designed as a resistance wire encased in plastic. The resistance wire is typically arranged in a meandering pattern and can detect a change in resistance caused by a change in the length of the lifting belt (to which the lifting belt strain gauge in the form of the resistance wire encased in plastic is attached). Further embodiments of the conveyor belt strain gauge comprise electrical sensor elements for detecting the change in length. Examples include piezoelectric, optical, inductive, and/or capacitive sensor elements.

According to a preferred embodiment of the present invention, the conveyor belt is provided with a strain gauge, wherein the weighing device associated with the conveyor belt has an evaluation unit for detecting a change in length of the strain gauge, wherein the evaluation unit is configured such that the weight of the food bar located on the conveyor belt can be determined as a function of the change in length of the strain gauge. By means of the strain gauge included in the conveyor belt, the weight of the food bars can preferably be determined already when the pre-tensioned conveyor belt is being loaded (in the loading position) on the basis of the change in length of the strain gauge detected thereby. Compared to the preloaded state of the conveyor belt, loading with the food bars results in a change in length, which can be detected by the strain gauge and determined by the evaluation unit. In an alternative embodiment of the invention, the detection and determination can also take place in the feed position of the conveyor belt. By measuring and/or providing the feed angle, the weight force of the food bars on the pre-tensioned conveyor belt can be determined within the evaluation unit in proportion to the feed position and taken into account when determining the weight of the food bars. The strain gauge is attached to the conveyor belt and the designs are the same as for the lifting belt strain gauge.

This embodiment of the present invention thus ensures extremely advantageous detection of a change in length of the tensioned conveyor belt by the strain gauge in the loading position or in the feed position and extremely advantageous determination of the weight of the food bars by the evaluation unit (in combination with the measurement and/or provision of the feed angle) due to the change in length.

Another subject matter of the present invention is a method for cutting food bars, in particular by means of the device for cutting food bars according to the invention, wherein food bars are fed to a cutting device for cutting, wherein the weight of the food bars is determined by means of a weighing device associated with the food feeding device, in particular during feeding.

The advantages and embodiments described in connection with the embodiments of the device for weighing food bars according to the invention can be applied to the method for weighing food bars or sticks.

### BRIEF DESCRIPTION OF THE DRAWINGS

FIG. 1 shows a schematic representation of a device for cutting food bars according to one embodiment of the invention.

FIG. 2a shows a schematic representation of the device for cutting food bars according to a further embodiment of the invention.

FIG. 2b shows a schematic representation of the device for cutting food bars according to a further embodiment of the invention.

FIG. 3 shows a schematic representation of the device for cutting food bars according to a further embodiment of the invention.

FIG. 4 shows a schematic representation of a device for cutting food bars according to a further embodiment.

### DETAILED DESCRIPTION

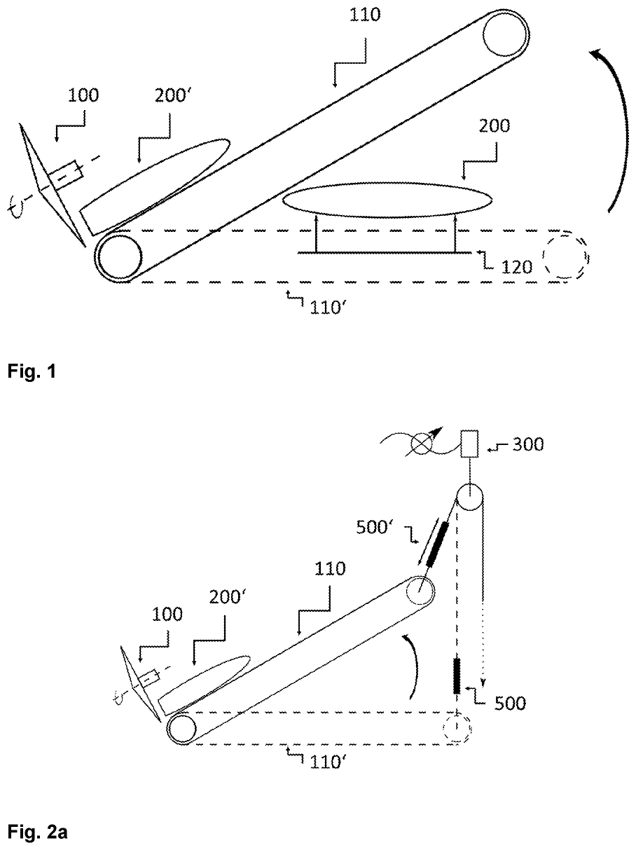

FIG. 1 shows a schematic representation of the device for cutting food bars 200, 200′ according to one embodiment of the invention. The device has a cutting device 100 for cutting the food bars 200, 200′ into product slices. The food bars 200, 200′ are fed to the cutting device 100 by means of a food feed device comprising a conveyor belt.

It can be seen that the conveyor belt carries a food bar 200′ in a loading position 110 and feeds it to the cutting device 100. Furthermore, the conveyor belt is shown in a loading position 110′ by means of dashed lines. Within the loading position 110′, a further food bar 200 (arranged there as an example) is lifted by means of a lifting device 120 and the weight of the further food bar 200 is determined by a load cell included in the lifting device 120. The lifting device 120 together with the load cell forms a weighing device which is integrated into the food feed device and is thus also associated with the food feed device.

An arrow indicates the swiveling of the conveyor belt from the loading position 110′ to the feed position 110. Furthermore, the conveyor belt has a conveying plane parallel to the conveyor belt. The lifting device 120 can be moved from a rest position to a working position and from the working position to the rest position, as well as to (stepless) intermediate positions (indicated by two arrows). Within the working position, the weight of the additional food bar 200 is determined as far as possible above the conveyor plane. This allows the conveyor belt to pick up a food bar 200 in the loading position 110′ and, by means of the lifting device 120, the food bar 200 can be lifted as vertically as possible to the conveyor plane (working position). In the working position, the weight of the food bar 200 can be weighed by means of the load cell. After weighing, the food bar 200 can be lowered again using the lifting device 120 (rest position) and the conveyor belt can be swiveled from the loading position 110′ to the feed position 110. This efficiently feeds the food bar 200′ to the cutting device 100. In the receiving position 110′, the food bar 200 can optionally be placed on the conveyor belt manually by an operator or by means of an external loading device (not shown).

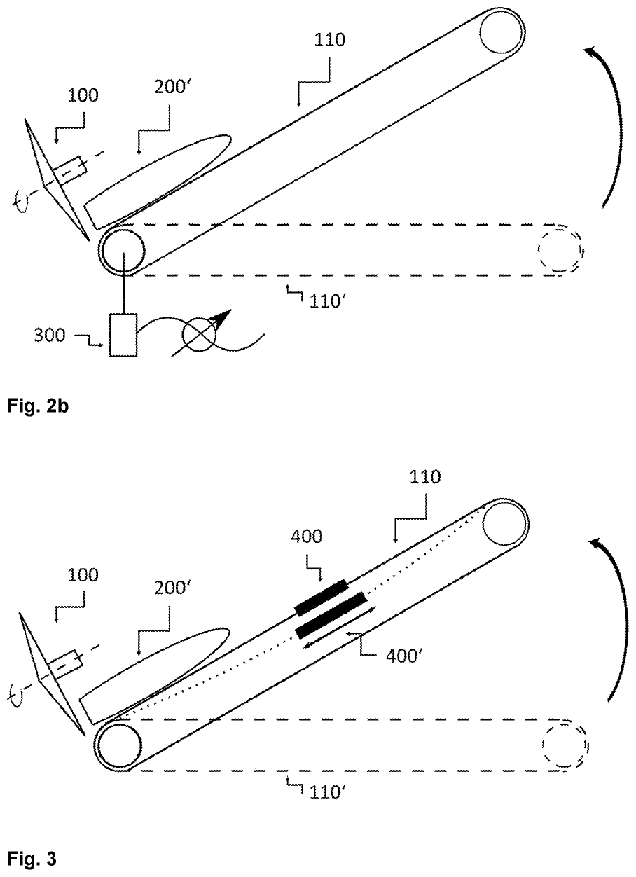

FIG. 2a shows a schematic representation of the device for cutting the food bar 200′ according to a further embodiment of the invention.

As in FIG. 1, FIG. 2a shows the cutting device 100 and the conveyor belt in the loading position 110′ and in the feed position 110. The conveyor belt, loaded with the food bar 200′, is raised and lowered by means of a lifting belt. The lifting belt is attached to a lifting drive, which can be designed in particular as an electric motor or a gear motor with a servo drive. The lifting force is transmitted by means of a toothed belt. Furthermore, a lifting belt strain gauge strip 500 is attached to the lifting belt 500′ is attached to the lifting belt, which has two different lengths (length 500 in loading position 110′ and length 500′ in feed position 110), depending on whether the conveyor belt loaded with the food bar 200′ is in loading position 110′ or in feed position 110. By comparing these two lengths 500, 500′ and the reference process (not explicitly shown here) of raising and lowering the unloaded conveyor belt, it is possible to advantageously detect changes in the length of the lift belt strain gauge 500, 500′ in the loaded state and distinguish them from the unloaded state. The change in length of the lifting belt strain gauge 500, 500′ is effectively and efficiently detected by means of a lifting belt evaluation unit. The weight of the food bar located on the conveyor belt can then be advantageously determined as a function of the change in length of the lifting belt strain gauge 500, 500′. Here, too, the weighing device is integrated into the food feed device and is therefore also associated with the food feed device.

One design of the lifting belt strain gauge can be a resistance wire enclosed in plastic and arranged in a meandering pattern, which undergoes a change in electrical resistance when its length changes. Furthermore, alternative or additional sensor elements, for example piezoelectric, optical, inductive, and/or capacitive sensor elements enclosed in plastic, are conceivable.

FIG. 2b shows a schematic representation of the device for cutting the food bar 200′ according to a further embodiment of the invention. As in the previous figures, FIG. 2b shows the cutting device 100 and the conveyor belt in the loading position 110′ and in the feed position 110. The lifting drive is used to pivot the conveyor belt, loaded with the food bar 200′, from the loading position 110′ to the feeding position 110. The power consumption of the lifting drive allows the weight of the food bar 200′ to be determined by the power evaluation unit 300 as a function of the power consumption of the lifting drive. The lifting drive can be implemented in particular by means of a spindle drive, which connects an electric motor to the conveyor belt via a spindle, or by means of a gear motor with a servo drive. In this case, the lifting force is also transmitted by means of a toothed belt. Furthermore, the lifting drive can also be designed using pneumatic or hydraulic cylinders. In the case of the spindle drive, the spindle is a simple mechanical connection that is not prone to failure. The power consumption of the electric motor or gear motor with a servo drive is recorded by the power evaluation unit 300 and converted by it into the weight force of the food bar 200′. Alternatively, it is also conceivable that the conveyor belt has a pivot bearing or radial bearing on the axis of rotation and is attached to the pneumatic or hydraulic cylinder on the opposite side. This also allows the power of the pneumatic or hydraulic cylinder to be recorded by the power evaluation unit 300 and effectively inferred from the weight of the food bar. In the course of the calculation or determination, it is advantageous to calculate the weight of, for example, the conveyor belt and the deflection rollers within the detection. The design for determining the weight of the food bar 200′ as a function of the power consumption of the lifting drive is also conceivable for the design described in FIG. 2a for pivoting the conveyor belt by means of the lifting belt attached to the lifting drive (and the associated power evaluation unit 300). The weighing device is again integrated into the food feed device and is therefore also associated with the food feed device.

In a further embodiment, a feed angle, which defines the angle between the loading position 110′ and the feed position 110, can be measured or provided. With the aid of the feed angle, the determination of the weight of the food bar 200′ acting on the conveyor belt can be advantageously supplemented within the performance evaluation unit 300 with regard to the power consumption.

An alternative embodiment in which the conveyor belt and other elements, such as the cutting device 100 and the food feed device itself, pivot around the feed angle from a total loading position to a total loading position is also conceivable.

FIG. 3 shows a schematic representation of a device for cutting the food bar 200′ according to a further embodiment of the invention. As in the previous figures, the cutting device 100 and the conveyor belt are shown in the feed position 110 and in the loading position 110′. Due to a strain gauge included in the conveyor belt, a change in length can be detected in comparison to the unloaded preloaded conveyor belt (not explicitly shown here), particularly when the preloaded conveyor belt is being loaded. Furthermore, when the conveyor belt is swiveled into the feed position 110, a change in length between the loaded pre-tensioned conveyor belt 400′ and the unloaded pre-tensioned conveyor belt 400 can also be detected by means of the strain gauge. However, this change in length must be processed with the aid (i.e., measurement or provision) of the feed angle, since the weight force of the food bar 200′ acting on the conveyor belt changes depending on the feed angle. Using an evaluation unit, the weight of the food bar 200′ can be determined both in the loading position 110′ and in the feed position 110 (in connection with the measurement or provision of the feed angle) on the basis of the recorded change in length. The weighing device is again integrated into the food feed device and is therefore also associated with the food feed device.

The possible designs of the strain gauge mounted on the conveyor belt are the same as those of the lifting belt strain gauge.

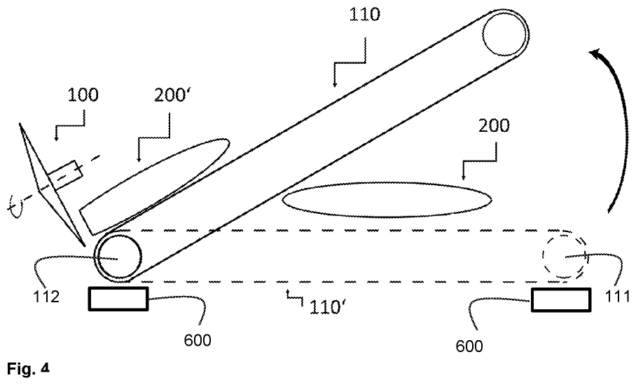

FIG. 4 shows a device for cutting food bars according to a further embodiment of the present invention. This embodiment is essentially similar to the device shown in FIG. 1. However, in the example shown in FIG. 4, the weighing device does not comprise a lifting device 120, but rather a load cell 600, which is arranged in the area of the pivot axis 112 for the conveyor belt. The conveyor belt can pivot between the feed position 110 and the loading position 110′ about this pivot axis 112. The load cell is associated with and arranged in relation to the food feed device in such a way that the weight force acting on the pivot axis and emanating from the entire feed device can be measured. In this way, it is possible to determine the weight of the food bar 200 lying on the conveyor belt, in particular when the conveyor belt is in the loading position.

Alternatively, it is conceivable that the weighing device has a further load cell which is located in the area of the pivoted deflection roller 111 of the conveyor belt. It is conceivable that the deflection roller 111 or its bearing acts on the additional load cell, so that the total weight of the conveyor belt or the food feed device can be determined by means of the load cell 600 and the additional load cell 600′. In this way, the weight of the food bar 200 located on the conveyor belt can also be determined when the conveyor belt is in the loading position 110′.

### LIST OF REFERENCE MARKS

100 Cutting device
110 Conveyor belt in a feed position
110 Conveyor belt in a loading position
120 Lifting device
200 Additional food bar
200 Food bar or stick
300 Performance evaluation unit
400 Unloaded preloaded conveyor belt
400′ loaded pre-tensioned conveyor belt
500 Lifting belt in the receiving position of the loaded conveyor belt
500 Lifting belt in the loading position of the loaded conveyor belt
600 Load cell
600 Additional load cell

1. Device for cutting food bars comprising:
a cutting device for cutting the food bars into product slices;
a food feed device that has a conveyor belt for feeding the food bars to the cutting device; and
a weighing device associated with the food feed device for weighing the food bars.

2. Device according to claim 1, wherein the conveyor belt has a conveyor plane, wherein the weighing device associated with the conveyor belt has a weighing cell with a lifting device, wherein the lifting device is movable between a working position and a rest position through the conveyor plane, wherein the lifting device is located in the working position substantially above the conveyor plane, and in the rest position the lifting device is located substantially below the conveyor plane, wherein the weighing cell is configured such that in the working position, a weight of a food bar lying on the weighing cell can be determined.

3. Device according to claim 1, wherein the conveyor belt can be pivoted between a loading position and a feed position by a lifting drive, wherein the weighing device associated with the conveyor belt has a power evaluation unit for determining power consumption of the lifting drive, wherein the power evaluation unit is configured such that a weight of the food bars can be determined as a function of the power consumption of the lifting drive.

4. Device according to claim 1, wherein the conveyor belt can be pivoted between a loading position and a feed position by a lifting belt, wherein the lifting belt has a lifting belt strain gauge, wherein the weighing device associated with the conveyor belt has a lifting belt evaluation unit for detecting a change in length of the lifting belt strain gauge, wherein the lifting belt evaluation unit is configured such that a weight of the food bar located on the conveyor belt can be determined as a function of a change in length of the lifting belt strain gauge.

5. Device according to claim 1, wherein the conveyor belt can be pivoted between a loading position and a feeding position by a lifting drive, wherein the weighing device has a load cell which is arranged in an area of a pivot axis of the conveyor belt and measures a weight of the food feed device in the loading position.

6. Device according to claim 1, wherein the conveyor belt can be pivoted between a loading position and a feeding position by a lifting drive, wherein the weighing device comprises a weighing cell which is arranged in a region of a pivot axis of the conveyor belt and a further weighing cell which is arranged in a region of a deflection roller of the conveyor belt, wherein the weighing cell and the further weighing cell together measure a weight of the food feed device in the loading position.

7. Device according to claim 1, wherein the conveyor belt has a strain gauge, wherein the weighing device associated with the conveyor belt has an evaluation unit for detecting a change in length of the strain gauge, wherein the evaluation unit is configured such that a weight of the food bars located on the conveyor belt can be determined as a function of a change in length of the strain gauge.

8. Method for cutting food bars with the device according to claim 1, wherein the food bars are fed to the cutting device for cutting by the food feed device, wherein a weight of the food bars is determined by a weighing device associated with the food feed device during feeding.

9. Method according to claim 8, wherein the food bars are fed to the cutting device in a conveyor plane, wherein the food bars are lifted through the conveyor plane by a lifting device, wherein the weight of the food bars is determined as far as possible above the conveyor plane by the weighing device.

10. Method according to claim 8, wherein the conveyor belt is pivoted by a lifting drive, wherein a power consumption of the lifting drive is measured, wherein the weight of the food bars is determined as a function of the power consumption.

11. Method according to claim 8, wherein the conveyor belt is pivoted by a lifting belt, wherein the lifting belt has a lifting belt strain gauge, wherein a change in length of the lifting belt strain gauge is detected by a lifting belt evaluation unit, wherein the weight of the food bars is determined as a function of the change in length of the lifting belt strain gauge.

12. Method according to claim 8, wherein the conveyor belt has a strain gauge, wherein a change in length of the strain gauge is detected by an evaluation unit, wherein the weight of the food bars is determined as a function of the change in length of the strain gauge.
